(19) United States
(12) Patent Application Publication
(10) Pub. No.: US 2026/0268455 A1
(43) Pub. Date: Sep. 10, 2026

(54) METHOD AND DEVICE FOR IMAGE RESTORATION

(71) Applicant: Seoul National University R&DB Foundation, Seoul (KR)

(72) Inventors: Jungwon Park, Seoul (KR); Joodeok Kim, Seoul (KR)

(73) Assignee: Seoul National University R&DB Foundation, Seoul (KR)

(21) Appl. No.: 19/562,366

(22) Filed: Mar. 10, 2026

(30) Foreign Application Priority Data
Mar. 10, 2025 (KR) 10-2025-0030917
Mar. 6, 2026 (KR) 10-2026-0040727

(51) Int. Cl. G06T 5/60; G06T 5/50

(52) U.S. Cl. CPC G06T 5/60; G06T 5/50; G06T 2207/20072; G06T 2207/20081; G06T 2207/20084

(57) ABSTRACT

An image restoration method according to an aspect includes: obtaining a single dataset including a plurality of raw images containing noise; estimating noise statistics by performing spatial correlation analysis among the raw images included in the single dataset; determining a blind-spot size based on the noise statistics; training a blind-spot neural network configured according to the determined blind-spot size in a self-supervised manner using the single dataset; and generating a restored image from the raw images using the blind-spot neural network.

### CROSS-REFERENCE TO RELATED APPLICATIONS

This application claims priority to Korean Patent Application Nos. 10-2025-0030917 (filed on Mar. 10, 2025) and 10-2026-0040727 (filed on Mar. 6, 2026), which are hereby incorporated by reference in their entirety.

### TECHNICAL FIELD

The present disclosure relates to a method and a device for image restoration.

### BACKGROUND OF THE INVENTION

In modern precision imaging fields, including medical diagnostic imaging (e.g., X-ray CT, MRI), space astronomical observation, live-cell fluorescence microscopy, scanning electron microscopy (SEM) for semiconductor nano-process inspection, and transmission electron microscopy (TEM), technologies for analyzing fine structural characteristics and dynamic changes of observation targets at high resolution play an important role.

Despite the continuous advancement of imaging hardware, there exists a fundamental limitation in that the waves or particles themselves used for measurement, such as photons or electron beams, can cause effects such as radiation exposure, phototoxicity, or structural damage to the target materials or biological tissues being observed. To minimize such damage, low-illumination or low-dose imaging techniques that limit the incident amount of signals are required.

However, in a low-dose environment, as the absolute number of signal particles reaching a detector becomes insufficient, Poisson noise inevitably occurs. In addition, physical limitations of pixelated detectors, coincidence loss, and mechanical or thermal drift that may occur during a time-series image acquisition process act as factors that induce structural noise and blur in the acquired raw data.

To remove such instrumental and physical noise, various traditional image denoising techniques, such as Gaussian filtering, bandpass filtering, Wiener filtering, and BM3D, have been proposed. However, these techniques have a limitation in that fine structural details and valid information of the observation target may also be reduced during the noise removal process.

As a method to compensate for this, deep learning denoising technologies based on artificial neural networks have been introduced. However, these technologies require noise-free ground-truth reference images during the training process. Nevertheless, in actual internal body imaging, biological dynamic observation environments, or nanoscale material observation environments, obtaining such ground-truth images is highly impractical due to dose limitations and the temporal reactivity of the targets.

Furthermore, depending on the imaging conditions, lighting environment, and lens and detector settings, the statistical characteristics of noise and the spatial diffusion patterns between adjacent pixels may appear different for each measurement environment. Due to this, when a denoising model pre-trained under specific conditions is applied to a different observation environment, applying such a pre-trained denoising model to a different observation environment may lead to degraded restoration performance or distortion.

Therefore, there is a demand for a new image restoration technology capable of estimating noise characteristics from a single acquired raw dataset and preserving the original structural information, without relying on ground-truth reference images.

### SUMMARY

### Technical Problem

An object of the present disclosure is to provide an image restoration method and an image restoration device addressing the physical limitations in acquiring a ground-truth reference image under low-illumination or low-dose imaging conditions applied to prevent damage to a target in observation environments using waves or particle beams, such as medical imaging, biological cell observation, astronomical observation, and transmission electron microscopy (TEM) analysis.

Another object of the present disclosure is to provide an image restoration method and an image restoration device capable of separating a noise pattern by utilizing a single raw image dataset itself, which contains noise, as a training input and an inference target, without requiring a separate clean training dataset.

Another object of the present disclosure is to provide an image restoration method and an image restoration device capable of estimating statistical characteristics of noise, which change depending on the type of imaging equipment, measurement dose rate, detector characteristics, and drift state of an observation sample, in a data-dependent manner through spatial correlation analysis among data tensors.

Another object of the present disclosure is to provide an image restoration method and an image restoration device capable of suppressing noise overfitting, in which a neural network learns an identity mapping of the noise pattern, and reducing the loss of structural information.

Another object of the present disclosure is to provide an image restoration method and an image restoration device capable of improving the accuracy and spatiotemporal resolution of structural restoration in time-series-based imaging environments such as dynamic cell observation, medical contrast agent tracking, and nanoparticle dynamics analysis.

In light of one or more deficiencies, drawbacks, and/or problems mentioned in the background art, the present disclosure is proposed to achieve one or more objects including solving or mitigating these problems.

The objects of the present disclosure are not limited to a specific object or problem to be solved. Other objects and technical tasks that the present disclosure seeks to solve will be clearly understood by those skilled in the art from combinations of various embodiments disclosed in the detailed description, the accompanying drawings, and the claims below.

These objects and technical advantages of the present disclosure may be realized through one or more components described in the appended claims and logical combinations thereof.

Furthermore, it is clarified that not all components described in the claims are necessarily included in all embodiments of the present disclosure.

### Technical Solution

An image restoration method according to an aspect may include: obtaining a single dataset including a plurality of raw images containing noise; estimating noise statistics by performing spatial correlation analysis among the raw images included in the single dataset; determining a blind-spot size based on the noise statistics; training a blind-spot neural network configured according to the determined blind-spot size in a self-supervised manner using the single dataset; and generating a restored image from the raw images using the blind-spot neural network.

In an aspect, the estimating of the noise statistics by performing the spatial correlation analysis among the raw images included in the single dataset may include: shifting a raw image tensor selected from the single dataset by a pixel unit in a first direction and a second direction, respectively; calculating correlation values between the shifted tensor and an original tensor; generating a two-dimensional (2D) spatial correlation heatmap using the correlation values; measuring a spatial diffusion radius in which a correlation value equal to or greater than a preset threshold is maintained in the 2D spatial correlation heatmap; and determining a physical blocking area in a form of N×N pixels (where N is an odd number equal to or greater than 1) as the blind-spot size in proportion to the number of pixels of the measured spatial diffusion radius.

In an aspect, the blind-spot neural network may include a dilated convolution layer. A dilation rate of the dilated convolution layer may be set based on the determined blind-spot size.

In an aspect, the raw images included in the single dataset may be provided as a training input of the blind-spot neural network and an inference target for calculating a loss function.

In an aspect, the training of the blind-spot neural network in the self-supervised manner may include: extracting a patch having a preset pixel size from the raw images included in the single dataset; augmenting training data by applying a geometric transformation to the patch; and self-updating a parameter by backpropagating a loss in a direction that minimizes a mean squared error (MSE) between a prediction result tensor of the blind-spot neural network and a raw image assigned as an inference target.

A device for image restoration according to an aspect may include: a data storage storing one or more instructions; and a processor executing the one or more instructions.

In an aspect, the processor may be configured to: obtain a single dataset including a plurality of raw images containing noise; estimate noise statistics by performing spatial correlation analysis among the raw images included in the single dataset; determine a blind-spot size based on the noise statistics; train a blind-spot neural network configured according to the determined blind-spot size in a self-supervised manner using the single dataset; and generate a restored image from the raw images using the blind-spot neural network.

In an aspect, when performing the spatial correlation analysis, the processor may be configured to: shift a raw image tensor selected from the single dataset by a pixel unit in a first direction and a second direction, respectively; calculate correlation values between the shifted tensor and an original tensor; generate a two-dimensional (2D) spatial correlation heatmap using the correlation values; measure a spatial diffusion radius in which a correlation value equal to or greater than a preset threshold is maintained in the 2D spatial correlation heatmap; and determine a physical blocking area in a form of N×N pixels (where N is an odd number equal to or greater than 1) as the blind-spot size in proportion to the number of pixels of the measured spatial diffusion radius.

In an aspect, the blind-spot neural network may include a dilated convolution layer. A dilation rate of the dilated convolution layer may be set based on the determined blind-spot size.

In an aspect, the raw images included in the single dataset may be provided as a training input of the blind-spot neural network and an inference target for calculating a loss function.

In an aspect, when training the blind-spot neural network, the processor may be configured to: extract a patch having a preset pixel size from the raw images included in the single dataset;

augment training data by applying a geometric transformation to the patch; and self-update a parameter by backpropagating a loss in a direction that minimizes a mean squared error (MSE) between a prediction result tensor of the blind-spot neural network and a raw image assigned as an inference target.

The components, steps, and their functional relationships described above are merely exemplary means representing one or more embodiments described in the claims of the present disclosure. As long as they do not depart from the technical spirit and scope of the present disclosure, the aforementioned components or steps may be replaced, omitted, or combined in various ways. Furthermore, the technical scope claimed by the present disclosure is not limited to a combination of all components and steps described in the claims.

### Advantageous Effects

First, the image restoration method and device according to the embodiments completely eliminate the greatest barrier to entry of conventional technologies, which requires separately acquiring flawless ground-truth datasets that consume substantial time and resources to train an artificial intelligence model. Instead, the present disclosure provides an innovative self-supervised learning framework that self-updates parameters using only a single raw image dataset inherently containing instrumental and physical noise. Through this, it has an excellent technical expansion effect capable of universally performing high-throughput, damage-free noise restoration without the cost of collecting separate reference data across a wide range of industrial and medical imaging fields-including low-dose medical X-ray CT and in situ transmission electron microscopy (TEM), which have inherent limitations in acquiring ground-truth images, as well as highly sensitive space astronomical observation images, low-illumination bio-fluorescence microscopy, and SEM for inspection of ultra-fine defects in semiconductor wafers.

Second, the image restoration method and device according to the embodiments completely depart from the conventional uniform approach of blindly applying a fixed filter or a pre-trained general-purpose neural network model in a specific environment. Whenever a new raw image dataset is acquired, spatial correlation analysis is performed within the corresponding single data to precisely estimate the physical dominant range of noise, and a customized blind-spot size (e.g., 3×3, 5×5, 9×9, etc.) that perfectly corresponds thereto is dynamically and variably formed. Based on the customized blind-spot derived in this way, the inflow of target pixel information within the receptive field is physically blocked at the source, thereby perfectly preventing a phenomenon in which the neural network learns an identity mapping of a specific noise pattern. As a result, compared to conventional single-image or video denoising self-supervised models (e.g., Noise2Void, UDVD, etc.), a peak signal-to-noise ratio (PSNR) improvement of up to approximately 20 decibels (dB) and a remarkable improvement in structural similarity (SSIM) reaching 0.9 are achieved. In addition, the image restoration method and device according to the embodiments provide a remarkable image quality improvement effect of perfectly removing only noise without losing valid structural information at the unit of human tissue, cells, space celestial bodies, or fine atoms.

### BRIEF DESCRIPTION OF THE DRAWINGS

FIG. 1 is a block diagram illustrating a configuration of a device for image restoration according to an exemplary embodiment.

FIG. 2 is a flowchart illustrating an overall flow of a method for image restoration according to an exemplary embodiment.

FIG. 3 is a flowchart illustrating a detailed flow of estimating noise statistics in a method for image restoration according to an exemplary embodiment.

FIG. 4 illustrates examples of two-dimensional (2D) spatial correlation heatmaps appearing in a method for image restoration according to an exemplary embodiment.

FIG. 5 is a flowchart illustrating a detailed flow of determining a blind-spot size in a method for image restoration according to an exemplary embodiment.

FIG. 6 is a flowchart illustrating a detailed flow of training a blind-spot neural network in a self-supervised manner in a method for image restoration according to an exemplary embodiment.

FIG. 7 is a diagram illustrating an internal operation structure of a blind-spot neural network according to an exemplary embodiment, and structurally and functionally comparing differences with a general convolutional operation module.

FIG. 8 illustrates actual experimental result images comparing the performance of an image restoration method according to an exemplary embodiment with conventional techniques and a comparative example.

FIG. 9 is a graph comparing quantitative performance metrics of an image restoration method according to an exemplary embodiment with conventional techniques.

### DETAILED DESCRIPTION OF THE INVENTION

The features, aspects, and advantages of the present disclosure will become more apparent by referring to the following detailed description and the accompanying drawings. To enable those skilled in the art to easily understand and practice the technical spirit of the present disclosure, the following detailed description includes exemplary embodiments for explaining the present disclosure and operational methods thereof.

The following description and drawings are provided as examples and explanations to describe the spirit and scope of the present disclosure, and are not intended to limit the present disclosure. Therefore, the scope of the present disclosure should not be unreasonably limited by these exemplary embodiments.

The arrangement and combinations of components, steps, operations, actions, and data values used in the present disclosure are to present specific examples of exemplary embodiments.

In certain embodiments, the arrangement and combinations of some components, steps, operations, actions, and/or data values may be omitted, modified, combined, or replaced. In addition, when it is determined that the gist of the present disclosure may be unnecessarily obscured, detailed descriptions of known technologies, known manufacturing methods, and configurations related to the present disclosure may be omitted.

In the following description and the accompanying drawings, identical reference numerals indicate identical or functionally similar components or parts. In describing a specific embodiment, a plurality of drawings may be referenced simultaneously.

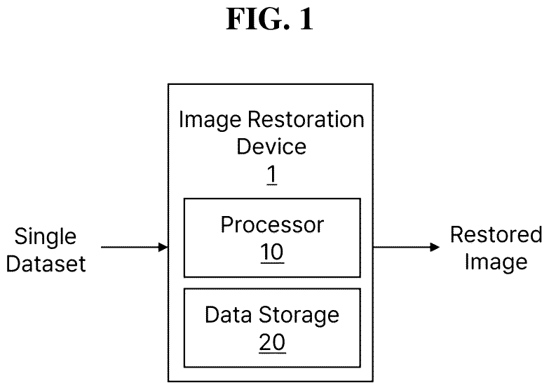

FIG. 1 is a block diagram illustrating a configuration of a device 1 for image restoration according to an exemplary embodiment.

Referring to FIG. 1, the device 1 for image restoration may include a processor 10 and a data storage 20.

The device 1 for image restoration may obtain a single dataset from an external device. The single dataset may include a plurality of raw images. At least one of the plurality of raw images may contain noise. In an exemplary embodiment, the raw images may be images acquired without a separate ground-truth image. That is, the single dataset may not include a reference image from which noise is removed.

At least one of the plurality of raw images may include various noises generated during an imaging process. The noise may include at least one of Poisson noise, signal dispersion across pixel boundaries, and noise caused by sample drift. Such noise may form spatial correlations among adjacent pixels. The spatial correlation of the noise may vary depending on the type of image and imaging conditions.

As examples, the raw images may include an image acquired by at least one of transmission electron microscopy (TEM), scanning transmission electron microscopy (STEM), and cryo-electron tomography (cryo-ET). As an example, the raw images may include an image acquired by a liquid cell in situ transmission electron microscope. As an example, the raw images may include an image acquired by a time-series scanning transmission electron microscope. As an example, the raw images may include an image acquired by at least one of an optical microscope, a fluorescence microscope, a low-dose X-ray CT, astronomical observation camera, and a scanning electron microscope (SEM). That is, the raw images included in the single dataset input to the device 1 for image restoration according to an exemplary embodiment are not limited to images acquired by a specific imaging device. The device 1 for image restoration according to an exemplary embodiment may be applied to all domains into which a single dataset including a plurality of raw images containing noise can be input.

The raw images may include time-series images. The time-series images may include a plurality of image frames continuously acquired in chronological order for the same imaging target. Each frame constituting the time-series images may include a noise pattern having a spatial correlation with other temporally adjacent frames.

The raw images may originate from a video captured by an imaging device connected to the device 1 for image restoration. The imaging device may be connected to the device 1 for image restoration via a wire or wirelessly. The video may include a plurality of frames continuously captured in chronological order. The raw images may be image frames extracted from at least a part of the plurality of frames constituting the video. That is, the single dataset may include a plurality of image frames extracted from the video.

The number of frames extracted from the video is not particularly limited. For example, all frames constituting the video may be used as the single dataset. Some of the entire frames constituting the video may be subsampled at preset frame intervals and used as the single dataset. In this way, since the single dataset can be configured using only the frames subsampled from the video, the device 1 for image restoration according to the present disclosure may be applied even to a dataset having a limited size.

Image frames originating from the video may include a noise pattern having a spatial correlation between temporally adjacent frames. Sample drift occurring during the video capturing process may cause asymmetry in the noise pattern between adjacent frames. Since the device 1 for image restoration according to the present disclosure can estimate various noise statistics including such asymmetric noise patterns through spatial correlation analysis, it can also be effectively applied to image frames originating from a video.

The imaging device may include at least one of a transmission electron microscope (TEM), a scanning transmission electron microscope (STEM), a cryo-electron tomography device (cryo-ET), an optical microscope, a fluorescence microscope, an X-ray CT device, and a scanning electron microscope (SEM). The type of imaging device is not limited thereto, and may include any device capable of capturing a video containing noise. In another embodiment, the device 1 for image restoration may obtain the single dataset from a device other than the imaging device.

The number of raw images included in the single dataset is not particularly limited. The single dataset may be composed of only a small number of frames. For example, the single dataset may include 20 or more frames. The single dataset may include 100 frames. As such, since the device 1 for image restoration according to the present disclosure does not require a large-scale dataset, data collection cost and time can be reduced.

The plurality of raw images and/or the single dataset including the plurality of raw images may be stored in the data storage 20.

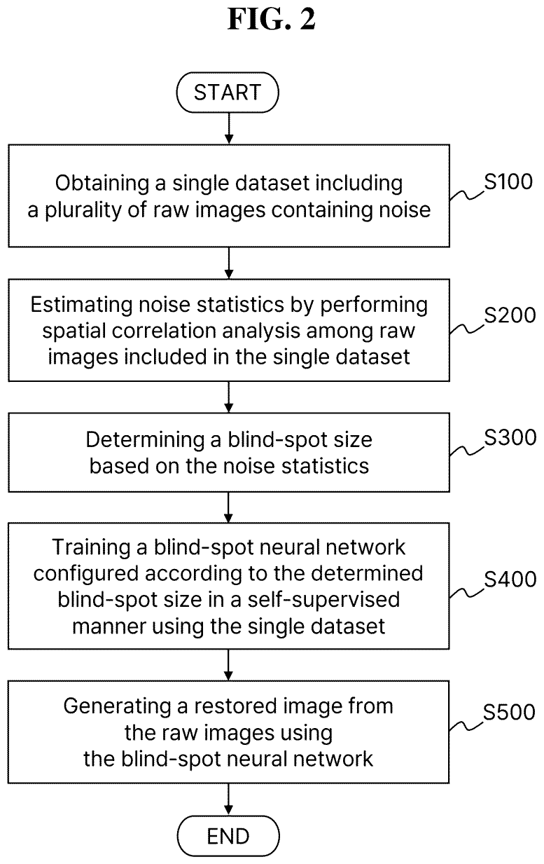

The processor 10 may execute one or more instructions stored in the data storage 20. The processor 10 may be configured to obtain the single dataset, estimate noise statistics by performing spatial correlation analysis, determine a blind-spot size based on the noise statistics, train a blind-spot neural network configured according to the determined blind-spot size in a self-supervised manner using the single dataset, and generate a restored image from the raw images using the trained blind-spot neural network. The processor 10 may dynamically train a new blind-spot neural network dependent on the corresponding dataset whenever a new single dataset is input. Detailed descriptions of each operation of the processor 10 will be described later with reference to FIGS. 2 to 6.

The processor 10 may include at least one of a Central Processing Unit (CPU), a Graphics Processing Unit (GPU), and a combination thereof. Since the training and inference operations of the blind-spot neural network correspond to compute-intensive tasks, it may be preferable for the processor 10 to include a GPU. However, the specific type of the processor 10 is not limited thereto, and may include all computing units capable of executing instructions.

The processor 10 may support automatic mixed precision operations utilizing a tensor core. The processor 10 can significantly reduce the computation time required for training and inference of a single dataset. The device 1 for image restoration can continuously restore large-scale electron microscopy images with high-throughput in real-time or near real-time. The device 1 for image restoration does not need to maintain or search a vast external training database, thereby maximizing the spatial efficiency of the data storage 20.

The data storage 20 may store one or more instructions executed by the processor 10. The data storage 20 may store the raw image dataset. The data storage 20 may store model parameters calculated during the training process of the blind-spot neural network. The data storage 20 may store a 2D spatial correlation heatmap generated by the spatial correlation analysis. The data storage 20 may store the determined blind-spot size information. The data storage 20 may include at least one of a Hard Disk Drive (HDD), a Solid State Drive (SSD), a flash memory, a Random

Access Memory (RAM), and combinations thereof. The specific type of the data storage 20 is not limited thereto, and may include all storage media capable of storing data and providing it to the processor 10.

The data storage 20 may store the model parameters calculated during the training process of the blind-spot neural network. The model parameters may include weights and biases of each layer constituting the blind-spot neural network. The model parameters may be repeatedly updated during the training process in a direction that minimizes a loss function. After the training is completed, model parameters at the time point showing an optimal validation loss may be stored in the data storage 20. The stored model parameters may be loaded by the processor 10 in the restored image generation step and used for inference of the blind-spot neural network.

A neural network is a computational structure composed of a plurality of nodes and connections between nodes, and may approximate a function that generates output data from input data. The neural network may include an input layer, one or more hidden layers, and an output layer. Each layer may include a plurality of nodes. Each node may generate an output value by multiplying an input value by a weight, adding a bias, and then applying an activation function.

The neural network can learn a desired input-output relationship through a training process of repeatedly updating weights and biases in a direction that minimizes a loss function based on training data.

A Convolutional Neural Network (CNN) is a type of neural network and may include a convolution layer that performs a convolution operation. The convolution layer may extract spatial features by applying a kernel to an input feature map. Since the CNN can effectively process the spatial structure of image data, it can be widely used in various image processing fields including image restoration, image classification, and object detection.

The blind-spot neural network is a type of CNN, and may be a neural network having a blind-spot structure that blocks information of an inference target pixel and its adjacent pixels. The blind-spot neural network may predict a noise-removed value of the target pixel using only information of surrounding pixels without directly referencing the inference target pixel. Such a blind-spot structure may enable training in a self-supervised manner using the same raw image as a training input and an inference target.

The model parameters of the blind-spot neural network may be individually optimized for each dataset during the training process. That is, the blind-spot neural network may generate a denoising model having unique model parameters reflecting the noise characteristics of each dataset. The model parameters of the trained blind-spot neural network may be stored in the data storage 20, and the processor 10 may load the stored model parameters to perform inference to generate a restored image from the raw images.

Although not illustrated, the data storage 20 may include a model parameter storage area that stores the model parameters of the blind-spot neural network. The model parameter storage area may be a logically or physically separated storage space within the data storage 20. The model parameters stored in the model parameter storage area may be read by the processor 10 and used for inference of the blind-spot neural network. The specific implementation method of the model parameter storage area is not particularly limited, and may be implemented in various ways apparent to those skilled in the art.

The processor 10 and the data storage 20 may be interconnected via a bus, an interface, or a communication channel. The processor 10 may read instructions and data from the data storage 20. The processor 10 may record operation results in the data storage 20.

The device 1 for image restoration may output a restored image based on the raw images included in the single dataset. The restored image may be an image from which noise is removed from the raw image using the trained blind-spot neural network. The restored image may have an improved Signal-to-Noise Ratio (SNR) compared to the raw image. The restored image may have an improved Peak Signal-to-Noise Ratio (PSNR) and Structural Similarity Index (SSIM) compared to the raw image. The restored image may be stored in the data storage 20. The restored image may also be provided to another device (not shown).

Although not illustrated, the device 1 for image restoration may further include a communication interface for receiving raw images from an external imaging device. Although not illustrated, the device 1 for image restoration may further include an output interface for transmitting the restored image to an external device. The specific types of the communication interface and the output interface are not particularly limited, and may include various wired or wireless communication means apparent to those skilled in the art.

FIG. 2 is a flowchart illustrating an overall flow of a method for image restoration according to an exemplary embodiment.

Referring to FIG. 2, the method for image restoration according to the exemplary embodiment may include: obtaining a single dataset including a plurality of raw images containing noise (S100); estimating noise statistics by performing spatial correlation analysis among the raw images included in the single dataset (S200); determining a blind-spot size based on the noise statistics (S300); training a blind-spot neural network configured according to the determined blind-spot size in a self-supervised manner using the single dataset (S400); and generating a restored image from the raw images using the blind-spot neural network (S500).

In step S100, the processor 10 of the device 1 for image restoration may obtain a single dataset including a plurality of raw images containing noise. The single dataset may not include a noise-removed ground-truth image. This may mean that the image restoration method according to the present disclosure can be performed only in a self-supervised manner without collecting ground-truth images. Collecting ground-truth images separately is practically extremely difficult or impossible in many cases due to lack of signals, sample drift, and variety of imaging conditions in a low-dose imaging environment. The image restoration method according to the present disclosure can overcome such constraints. The single dataset may be provided to the processor 10 from an external device or the data storage 20. Specific details of the single dataset are the same as described above with reference to FIG. 1.

In step S200, the processor 10 may estimate noise statistics by performing spatial correlation analysis among the raw images included in the single dataset. The noise statistics may include information about the spatial influence range of noise on adjacent pixels within the raw image. The noise statistics may vary depending on image capturing conditions and types of imaging devices.

In the present specification, “noise statistics” may comprehensively refer to mathematical and statistical characteristics of noise inherently embedded in a raw image. Noise statistics may refer to an index quantifying spatial ripple effects that noise, generated by instrumental limitations or physical factors of an imaging process, has on surrounding adjacent pixels. Noise statistics may include information about spatial dependencies and variance correlations among noise pixels. Depending on the type of imaging equipment, set dose rate, physical characteristics of a detector, or sample drift state, noise statistics may appear differently in every imaging session. The processor 10 can precisely estimate the noise statistics unique to a single dataset in a data-dependent manner through spatial correlation analysis.

In the present specification, “estimating noise statistics” may refer to a series of computational processes that mathematically reverse-calculate and quantify an unknown noise distribution characteristic using only raw data in an uncertain environment where ground-truth images are entirely absent. The processor 10 can precisely calculate spatial correlations among pixels inside a raw image tensor. The processor 10 can generate a 2D spatial correlation heatmap based on the calculated correlations. The processor 10 can analyze a shape and diffusion radius of the generated 2D spatial correlation heatmap. Through the heatmap analysis, the processor 10 can indirectly identify the range and directionality of physical ripple effects that noise exerts on adjacent pixels. As such, the entire algorithmic process of mathematically finalizing the dominating radius of invisible noise through spatial correlation analysis of the single dataset itself, without separate external reference data, may be defined as an operation of estimating noise statistics.

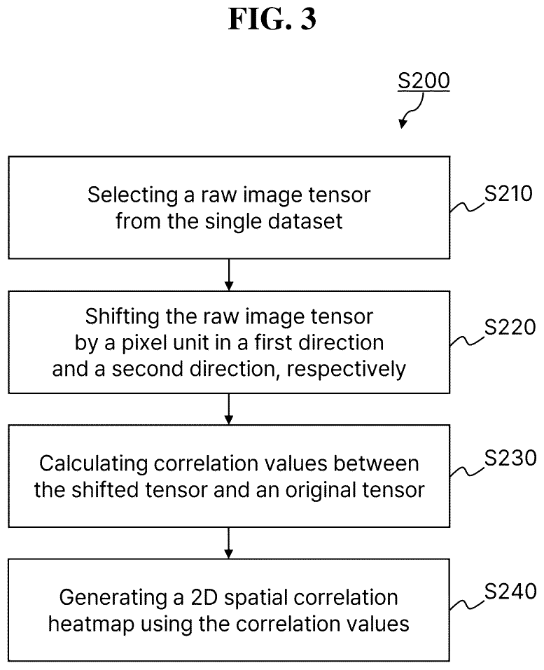

Conventional self-supervised denoising methods assumed that noise statistics were known in advance, or used a blind-spot of a single pixel size. However, in real environments, such as electron microscope environments, noise statistics are mostly unknown, and noise correlations among pixels cannot be sufficiently removed with a blind-spot of a single pixel size. Since the image restoration method according to the present disclosure estimates noise statistics by performing spatial correlation analysis individually for each dataset, it can be used even when noise statistics are not known in advance. Detailed contents of step S200 will be described later with reference to FIG. 3.

In step S300, the processor 10 may determine a blind-spot size based on the noise statistics estimated in step S200. The blind-spot size may be a value defining a spatial range of pixels that the blind-spot neural network cannot reference during inference, in a form of N×N pixels (where N is an odd number equal to or greater than 1). The blind-spot size may be automatically determined based on the spatial diffusion radius of noise. When the blind-spot size is determined to be smaller than the spatial diffusion radius of noise, the blind-spot neural network may fail to sufficiently block a noise pattern, resulting in noise overfitting. By appropriately determining the blind-spot size to match the spatial diffusion radius of noise, effective denoising can be performed without noise overfitting.

In the present disclosure, the spatial diffusion radius of noise may mean a physical limit distance over which instrumental or physical noise initially occurring at a single pixel location spreads to adjacent surrounding pixel areas. The spatial diffusion radius of noise may comprehensively refer to a range in pixel units where noise signals spread with spatial dependencies due to scattering of electron beams, resolution limits of a detector sensor, spreading of a point spread function, or sample drift phenomena occurring during imaging. Adjacent pixels located within the spatial diffusion radius of noise may have strong statistical correlations and data dependencies with each other. The process of accurately measuring the spatial diffusion radius of noise may be essentially required to fundamentally prevent an overfitting phenomenon in which the blind-spot neural network mistakenly learns a noise pattern of surrounding pixels as valid information and learns an identity function.

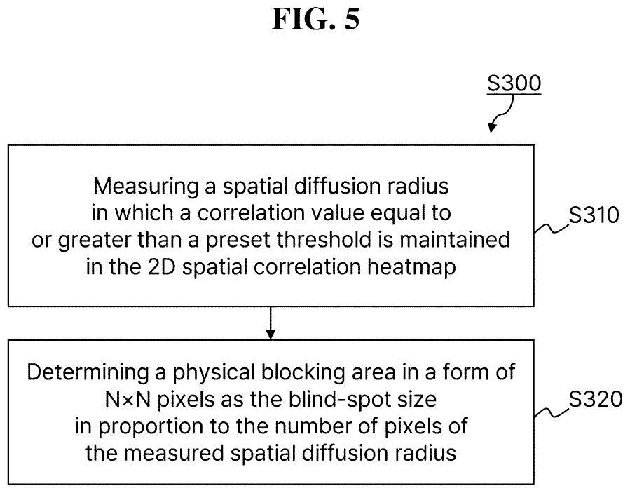

In the present disclosure, the spatial diffusion radius of noise may mean a maximum pixel range in which a correlation value equal to or greater than a preset threshold is continuously maintained within a 2D spatial correlation heatmap. The preset threshold may mean a mathematical lower limit of a correlation value by which it can be determined that noise exerts a statistically significant interference effect on adjacent pixels. The preset threshold may be set differently in a data-dependent manner depending on the type of imaging equipment, lens conditions, and observation environment. The processor 10 can finally determine the spatial diffusion radius of noise by calculating a pixel distance from a center of the 2D spatial correlation heatmap to a boundary point where significant correlation values are cut off, based on the preset threshold. Detailed contents of step S300 will be described later with reference to FIG. 5.

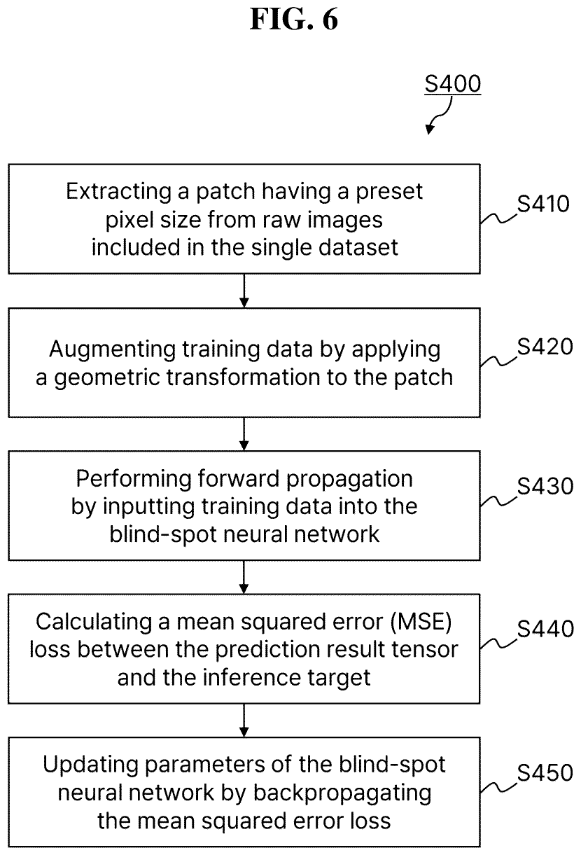

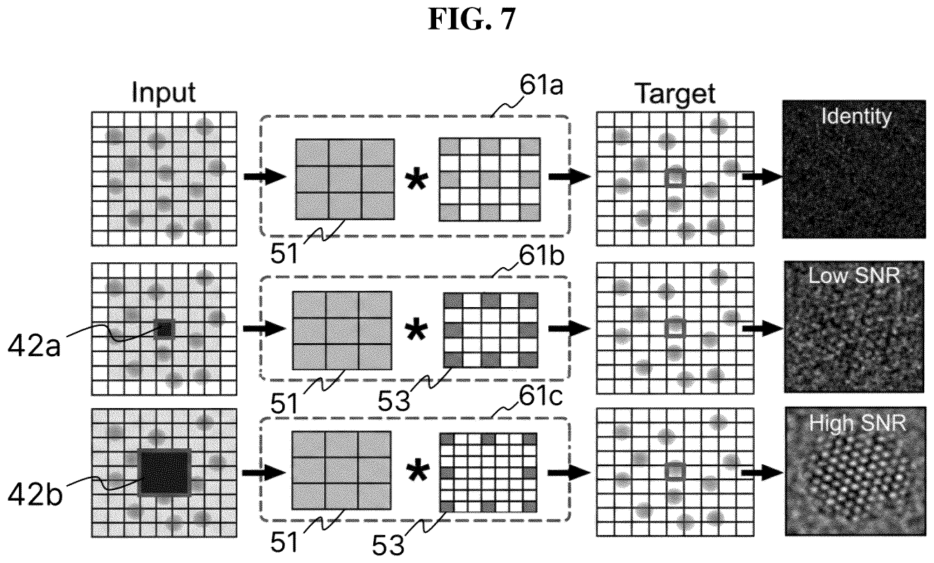

In step S400, the processor 10 may train a blind-spot neural network configured according to the blind-spot size determined in step S300 in a self-supervised manner using the single dataset. Training in a self-supervised manner may be performed by simultaneously providing a raw image included in the single dataset as a training input of the blind-spot neural network and an inference target for calculating a loss function. That is, the blind-spot neural network can be trained without separate ground-truth images. Detailed contents of step S400 will be described later with reference to FIG. 6. A structure of the blind-spot neural network will be described later with reference to FIG. 7.

In step S500, the processor 10 may generate a restored image from the raw images using the blind-spot neural network trained in step S400. The restored image may be an image from which noise contained in the raw image is removed. The restored image may have at least one of improved SNR, PSNR, and SSIM compared to the raw image. The generated restored image may be stored in the data storage 20. The generated restored image may be output to the outside of the device 1 for image restoration.

Steps S100 to S500 shown in FIG. 2 may be performed in sequential order. Steps S100 to S500 may be executed by the processor 10. Instructions corresponding to steps S100 to S500 may be stored in the data storage 20.

FIG. 3 is a flowchart illustrating a detailed flow of estimating noise statistics in a method for image restoration according to an exemplary embodiment.

In an exemplary embodiment, step S200 may include: selecting and standardizing a raw image tensor (S210); shifting the raw image tensor by a pixel unit (S220); calculating correlation values between the shifted tensor and an original tensor (S230); and generating a 2D spatial correlation heatmap (S240).

In step S210, the processor 10 may select a raw image from a single dataset. The processor 10 may convert the selected raw image into an image tensor. The processor 10 may standardize the image tensor. Standardization may include a process of adjusting a mean of the image tensor to 0 and a variance to 1. Through standardization, the range of pixel values of the image tensor can be normalized, thereby increasing the accuracy of subsequent correlation value calculation. Step S210 is a preprocessing step of spatial correlation analysis, and may directly affect the accuracy of steps S220 to S230.

In step S220, the processor 10 may shift the standardized raw image tensor by a pixel unit in a first direction and a second direction, respectively. For example, the first direction may be a horizontal direction (x-direction) of an image, and the second direction may be a vertical direction (y-direction) of an image. The processor 10 may sequentially shift the image tensor by 1 pixel in the first direction. The processor 10 may sequentially shift the image tensor by 1 pixel in the second direction. A shifting range may be set differently depending on an expected spatial influence range of noise.

In step S230, the processor 10 may calculate correlation values between the tensor shifted in step S220 and an original tensor. A correlation value may be calculated by the following equation for two image tensors x and y.

$$Correlation = \frac{{\sum }_{i} ( {x}_{i} - 〈 {x}_{i} 〉 ) ( {y}_{i} - 〈 {y}_{i} 〉 )}{{[ {\sum }_{i} {( {x}_{i} - 〈 {x}_{i} 〉 )}^{2} {\sum }_{i} {( {y}_{i} - 〈 {y}_{i} 〉 )}^{2} ]}^{1 / 2}} \qquad [ Equation 1 ]$$

Here, xᵢ and yᵢ represent the i-th pixel values of the original tensor and the shifted tensor, respectively, and <⋅> represents an average value. The correlation value may have a value from −1 to 1. The closer the correlation value is to 1, the more it indicates that the noise patterns between the two tensors have high similarity. The closer the correlation value is to 0, the more it indicates that the noise patterns between the two tensors are independent.

In an exemplary embodiment, the processor 10 may repeatedly perform steps S220 and S230 a plurality of times to calculate a plurality of correlation values corresponding to each shifting direction and shifting distance.

In step S240, the processor 10 may generate a 2D spatial correlation heatmap by collecting the plurality of correlation values calculated in step S230. The 2D spatial correlation heatmap is a visualization of the spatial influence range exerted by noise on adjacent pixels in a 2D matrix form. The 2D spatial correlation heatmap may exhibit a distribution having high correlation values at a center and decreasing correlation values as a distance from the center increases. The 2D spatial correlation heatmap may be stored in the data storage 20.

Noise statistics may be uniformly spatially correlated over an entire area in an image. The processor 10 can verify this by dividing the image into a plurality of partial areas, individually calculating noise correlation of each partial area, and comparing it with noise correlation of the entire image. When it is verified that noise is uniformly spatially correlated over the entire image, it may be reasonable to use the 2D spatial correlation heatmap for the entire image as a basis for determining a blind-spot size.

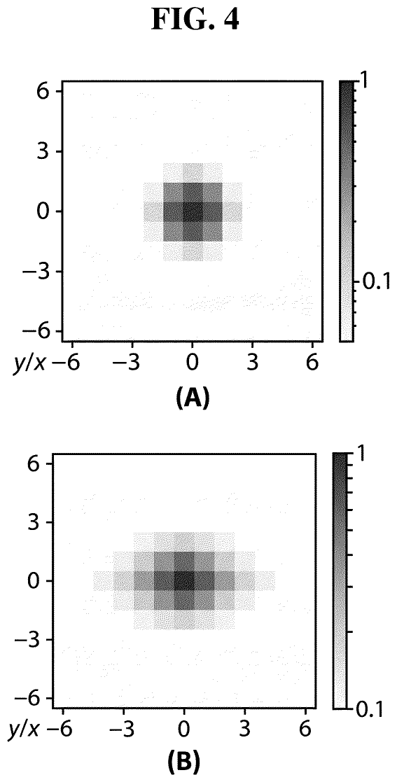

FIG. 4 illustrates examples of 2D spatial correlation heatmaps appearing in a method for image restoration according to an exemplary embodiment.

The 2D spatial correlation heatmap may appear symmetrically or asymmetrically depending on imaging conditions. In FIG. 4, (A) shows an example of a symmetric heatmap, and (B) shows an example of an asymmetric heatmap. The structures and shapes of symmetric heatmaps and asymmetric heatmaps may vary depending on embodiments.

A symmetric heatmap may appear when the spatial influence of noise is uniformly distributed in a first direction and a second direction. For example, in the case of a raw image acquired in a silicon nitride liquid cell TEM environment, a symmetric heatmap showing high correlation within a distance of 4 pixels may be generated.

An asymmetric heatmap may appear when the spatial influence of noise is biased and distributed in a specific direction. For example, in a time-series STEM environment, noise patterns may appear asymmetrically due to sample drift occurring during a raster scan process, and an asymmetric heatmap corresponding thereto may be generated.

The processor 10 does not need to precede complex and cumbersome image alignment or a separate drift correction algorithm. The direction and physical trajectory of sample drift can be completely reflected mathematically in the 2D spatial correlation heatmap itself. The image restoration method according to the present disclosure can immediately absorb a distorted noise pattern in a data-dependent manner and reflect it in a model.

Since the image restoration method according to the present disclosure can determine an appropriate blind-spot size for both symmetric and asymmetric heatmaps, it can be universally applied to raw images acquired under various imaging conditions.

When step S240 is completed, the processor 10 may perform step S310 of FIG. 5.

FIG. 5 is a flowchart illustrating a detailed flow of determining a blind-spot size in a method for image restoration according to an exemplary embodiment.

Referring to FIG. 5, step S300 may include: measuring a spatial diffusion radius (S310); and determining a blind-spot size (S320). Step S300 may be performed by receiving the 2D spatial correlation heatmap generated in step S240 of FIG. 3 as input.

In step S310, the processor 10 may measure a spatial diffusion radius of noise by analyzing the 2D spatial correlation heatmap generated in step S240. The spatial diffusion radius may mean a pixel range in which a correlation value equal to or greater than a preset threshold is maintained in the 2D spatial correlation heatmap. The preset threshold may mean a lower limit of a correlation value capable of determining that noise exerts a significant influence on adjacent pixels. The preset threshold may be set differently depending on embodiments.

In an exemplary embodiment, the processor 10 may measure, as a spatial diffusion radius, a maximum pixel distance in which a correlation value equal to or greater than a preset threshold is maintained from a center of a 2D spatial correlation heatmap in a first direction and a second direction, respectively.

In step S320, the processor 10 may determine a blind-spot size in proportion to the number of pixels of the spatial diffusion radius measured in step S310.

In an exemplary embodiment, the processor 10 may determine the blind-spot size in the form of N×N (where N is an odd number equal to or greater than 1) pixels. In other words, the blind-spot size may be determined as the minimum odd-number size capable of covering the spatial diffusion radius of noise. For example, if a spatial diffusion radius is 0 pixels, a blind-spot size may be determined as 1×1. If a spatial diffusion radius is approximately 1 pixel, a blind-spot size may be determined as 3×3. If a spatial diffusion radius is approximately 2 pixels, a blind-spot size may be determined as 5×5. If a spatial diffusion radius is approximately 4 pixels, a blind-spot size may be determined as 9×9.

When a blind-spot size is determined to be smaller than the spatial diffusion radius of noise, the blind-spot neural network fails to sufficiently block noise, and thus noise overfitting may occur. Conversely, when a blind-spot size is excessively determined to be larger than the spatial diffusion radius of noise, the blind-spot neural network may unnecessarily block even valid structural information. In this case, a resolution of a restored image may be degraded or a blur phenomenon in which fine details are lost may occur.

When a blind-spot size is determined appropriately for the spatial diffusion radius of noise, the blind-spot neural network can effectively remove noise without noise overfitting. As such, since the image restoration method according to the present disclosure automatically determines a blind-spot size based on noise statistics, an optimized blind-spot size can be determined even under various imaging conditions where noise statistics are not known in advance.

The spatial diffusion radius of noise may appear differently depending on image capturing conditions and types of imaging devices. For example, when a Charge-Coupled Device (CCD) or a Direct Electron Detector (DED) is used in a linear acquisition mode, a received electron signal may be dispersed more widely than a size of a physical sensor pixel, thereby forming noise dependencies among adjacent pixels. As another example, in STEM imaging, a raster scan and sample drift may change noise dependencies among pixels. Since the image restoration method according to the present disclosure can automatically determine a blind-spot size by individually performing steps S200 and S300 for each dataset, it can be universally applied to various imaging conditions and imaging devices.

The determined blind-spot size may be stored in the data storage 20. When step S320 is completed, the processor 10 may perform step S400 of FIG. 2.

FIG. 6 is a flowchart illustrating a detailed flow of training a blind-spot neural network in a self-supervised manner in a method for image restoration according to an exemplary embodiment.

In an exemplary embodiment, a raw image included in a single dataset may be simultaneously provided as a training input of a blind-spot neural network and an inference target for calculating a loss function of the blind-spot neural network. That is, the training input and the inference target may be provided from the same raw image, not a separate ground-truth image. Such a self-supervised manner enables a blind-spot neural network to be trained without separately collecting ground-truth images.

In an exemplary embodiment, through a blind-spot structure blocking information of an inference target pixel and its adjacent pixels, the blind-spot neural network may not learn an identity function simply copying an input even when using the same raw image as a training input and an inference target. The blind-spot neural network can be trained to predict a noise-removed value of a corresponding pixel using only information of surrounding pixels without directly referencing the inference target pixel.

Referring to FIG. 6, step S400 may include: extracting a patch (S410); applying a geometric transformation (S420); forward propagating the blind-spot neural network (S430); calculating an MSE loss (S440); and performing backpropagation (S450).

In step S410, the processor 10 may extract a patch having a preset pixel size from raw images included in a single dataset. The patch may be an area randomly cropped from a raw image. A pixel size of a patch is not particularly limited. For example, a pixel size of a patch may be 256×256 pixels. Patch extraction through random cropping can suppress overfitting by preventing the blind-spot neural network from fully memorizing specific noise patterns. The processor 10 may extract a new patch at each iteration of a training process.

In step S420, the processor 10 may augment training data for training the blind-spot neural network by applying geometric transformations to the patch extracted in step S410. In an exemplary embodiment, geometric transformations may include at least one of rotation and inversion. Rotation may include rotating the patch in units of 90°. Inversion may include at least one of inverting the patch in a horizontal direction and inverting the patch in a vertical direction. Data augmentation can create more training data from a single dataset of a limited size, thereby improving the generalization performance of the blind-spot neural network. In another embodiment, step S420 may be omitted.

In step S430, the processor 10 may perform forward propagation by inputting training data into the blind-spot neural network. The blind-spot neural network may be configured according to the blind-spot size determined in step S300. A structure of the blind-spot neural network will be described later with reference to FIG. 7.

The blind-spot neural network may use one or more frames temporally adjacent to an inference target frame together as input. For example, the blind-spot neural network may use a total of 5 frames, including an inference target frame and 4 temporally adjacent frames, as input. By utilizing temporal information of adjacent frames, a prediction accuracy of the blind-spot neural network can be improved. The blind-spot neural network can generate a prediction result tensor including a noise-removed predicted value of an inference target pixel through forward propagation.

In step S440, the processor 10 may calculate a Mean Squared Error (MSE) loss between the prediction result tensor generated in step S430 and a raw image assigned as an inference target. The MSE loss may be calculated by the following equation.

$$L ( {x}_{i}^{j} , {x}_{i}^{′ j} ) = {( {x}_{i}^{j} - {x}_{i}^{′ j} )}^{2} \qquad [ Equation 2 ]$$

Here,

$${x}_{i}^{j}$$

represents a pixel value of an inference target corresponding to the i-th pixel of the j-th frame, and

$${x}_{i}^{′ j}$$

represents a predicted value of the blind-spot neural network. The processor 10 may optimize parameters of the blind-spot neural network in a direction that minimizes the MSE loss.

In step S450, the processor 10 may self-update or iteratively update parameters of the blind-spot neural network by backpropagating the MSE loss calculated in step S440. Parameter updating may be performed by an optimization algorithm. For example, the optimization algorithm may include a Rectified Adam (RAdam) optimizer. For example, a learning rate may be adjusted by a warm-up and cosine annealing scheduler. Specific types of the optimization algorithm and the learning rate scheduler are not limited thereto, and various optimization algorithms and learning rate schedulers apparent to those skilled in the art may be applied.

Minimization of an empirical risk of training may be defined by the following equation.

$${arg min}_{θ} {\sum }_{i} {\sum }_{j} L \{ f [ {x}_{RF ( i )}^{j} ; θ ] , {x}_{i}^{j} \} \qquad [ Equation 3 ]$$

Here, θ represents parameters of the blind-spot neural network,

$${x}_{RF ( i )}^{j}$$

represents a receptive field input (with blind-spot constraints applied) for the i-th pixel of the j-th frame, and

$${x}_{i}^{j}$$

represents an inference target pixel value. The processor 10 may repeat step S450 to progressively optimize the parameter θ.

The processor 10 may determine whether the blind-spot neural network has converged after step S450. Convergence may be determined based on a validation loss. For example, the processor 10 may separate some images from a single dataset as a validation dataset and calculate a validation loss. When the validation loss does not satisfy a preset criterion, the processor 10 may return to step S410 and repeat training. When the validation loss satisfies the preset criterion, the processor 10 may terminate training and store model parameters at a time point showing an optimal validation loss in the data storage 20.

The number of training epochs may be adjusted according to a size of a dataset. For example, training may be performed for 2000 epochs for most datasets. Training may be performed for 100 epochs for a cryo-ET dataset.

When step S450 is completed, a blind-spot neural network may be generated. Accordingly, the processor 10 may perform step S500 of FIG. 2. That is, the processor 10 may generate a restored image corresponding to a raw image using the blind-spot neural network.

FIG. 7 is a diagram illustrating an internal operation structure of a blind-spot neural network according to an exemplary embodiment, and structurally and functionally comparing differences with a general convolutional operation module.

In FIG. 7, an input grid (left), a dotted rectangle representing a convolution operation structure (center), and prediction output results for an inference target (right) are illustrated divided into 3 rows.

The 3 dotted rectangles arranged in the center of FIG. 7 indicate independent and individually driven operation modules 61a, 61b, and 61c, respectively. Inside each operation module, a 3×3 convolution kernel 51 and a dilated convolution layer 53 may be selectively disposed.

The first row of FIG. 7 illustrates a structure of an operation module 61a to which a blind-spot structure is not applied at all. The operation module 61a is a general convolution operation module to which blind-spot constraints for blocking information are not applied. Inside the operation module 61a, a 3×3 convolution kernel 51 is disposed. The operation module 61a performs prediction by referencing information of the entire receptive field of the network including an inference target pixel without filtering. In this case, the operation module 61a directly references a value of the inference target pixel itself. When the same raw image is simultaneously used as a training input and an inference target, a neural network including the operation module 61a learns an identity function that simply copies and outputs input noise pixel values. An output image (Identity) shown on the right side of the first row indicates a failed restoration result in which noise is not removed at all due to the learning of the identity function. As such, without a blind-spot structure, it is impossible to learn a valid denoising model via self-supervised training.

The second row of FIG. 7 illustrates a structure of an operation module 61b in which a blind-spot size 42a is set to 1×1 pixels. The operation module 61b is an operation module to which a 1×1 size ideal blind-spot is applied. Inside the operation module 61b, a 3×3 convolution kernel 51 and a dilated convolution layer 53 are disposed. The operation module 61b physically blocks only 1 inference target pixel. From the input grid on the left side of the second row, it can be seen that only a 1×1 area corresponding to an inference target pixel is blocked. When a blind-spot size 42a is 1×1, the operation module 61b blocks a value of an inference target pixel itself, but references all values of immediately adjacent pixels. When noise of adjacent pixels is spatially strongly correlated with noise of an inference target pixel such that a spatial diffusion radius of noise exceeds 1 pixel, noise information indirectly leaks into the operation module 61b through adjacent pixels allowed to be referenced. When noise information leaks, a neural network including the operation module 61b experiences noise overfitting in which it mistakenly learns a noise pattern itself as valid structural information. An output image (Low SNR) shown on the right side of the second row shows an incomplete restoration result indicating a low Signal-to-Noise Ratio (SNR) as noise overfitting occurs because the blind-spot size 42a is set smaller than the actual spatial diffusion radius of noise.

The third row of FIG. 7 illustrates a structure of an operation module 61c in which a blind-spot size 42b is set to 3×3 pixels. The operation module 61c is an operation module to which a 3×3 size real blind-spot is applied. Inside the operation module 61c, a 3×3 convolution kernel 51 and a dilated convolution layer 53 are disposed. The operation module 61c physically blocks information of a total 3×3 area including an inference target pixel and 8 adjacent pixels surrounding the inference target pixel. From the input grid on the left side of the third row, it can be seen that an entire 3×3 area is bundled into one large area and blocked. When a blind-spot size 42b is 3×3, the operation module 61c structurally blocks all adjacent pixel information existing within the spatial diffusion radius of noise. As the inflow of information is blocked, a neural network including the operation module 61c fundamentally avoids noise overfitting and predicts a target pixel value using only valid structural information from the periphery. An output image (High SNR) shown on the right side of the third row indicates a result of generating a restored image with a high SNR from which noise is removed because the blind-spot size 42b is set appropriately for the spatial diffusion radius of noise.

Referring to the second row and the third row of FIG. 7, the operation modules 61b and 61c include a dilated convolution layer 53. In an exemplary embodiment, the processor 10 can physically maintain blind-spot constraints while expanding a receptive field by adjusting a dilation rate of the dilated convolution layer 53.

A dilation rate of the dilated convolution layer 53 may be set in conjunction with the blind-spot size determined in step S300. As a dilation rate increases, a size of a blind-spot may increase. For example, if a blind-spot size is 1×1, a dilation rate may be set to 1. If a blind-spot size is 3×3, a dilation rate may be set to 2. If a blind-spot size is 5×5, a dilation rate may be set to 3. A specific value of a dilation rate is not limited thereto, and may be adjusted within a range apparent to those skilled in the art according to a blind-spot size.

In FIG. 7, the receptive field of the network indicates a spatial range of an entire pixel area referenced when each operation module 61a, 61b, and 61c infers a single pixel. In FIG. 7, an electron signal indicates a scattering distribution of a raw signal including blur effects received from each pixel of an electron microscope or camera detector. The dilated convolution layer 53 collects valid context information for prediction from a wide receptive field located outside the entirely blocked blind-spot area.

When performing prediction for a single pixel i, a blind-spot neural network including operation modules 61b and 61c uses only remaining pixel information obtained by blocking pixel information corresponding to a blind-spot size from a receptive field x_RF(i) including the pixel i and adjacent pixels thereof. A function of the blind-spot neural network including operation modules 61b and 61c can be defined as follows.

$$f [ {x}_{RF 〈 i )} ; θ ] = {x}_{i}^{′} \qquad [ Equation 4 ]$$

Here, θ represents parameters of the blind-spot neural network, and

$${x}_{i}^{′}$$

represents a predicted value of pixel i. The blind-spot neural network predicts a noise-removed value of pixel i using only surrounding pixel information without directly referencing information of pixel i. Due to such a physical blocking structure, the blind-spot neural network does not learn an identity function even when simultaneously using the same raw image as a training input and an inference target.

As shown in FIG. 7, a restored image having a high SNR is generated only when a blind-spot size is determined appropriately for a spatial diffusion radius of noise (61c, 42b). This visually supports the technical significance that the image restoration method according to the present disclosure includes a step (S300) of automatically determining a blind-spot size based on noise statistics.

Training of the blind-spot neural network may be performed individually for each dataset without relying on general-purpose external data. The blind-spot neural network can generate denoising model parameters optimized for inherent noise characteristics and diffusion radii possessed by each dataset. Although not illustrated, the blind-spot neural network may support mixed precision calculation to improve training and inference speed. A specific implementation method of the blind-spot neural network is not limited thereto, and may be changed within a range apparent to those skilled in the art.

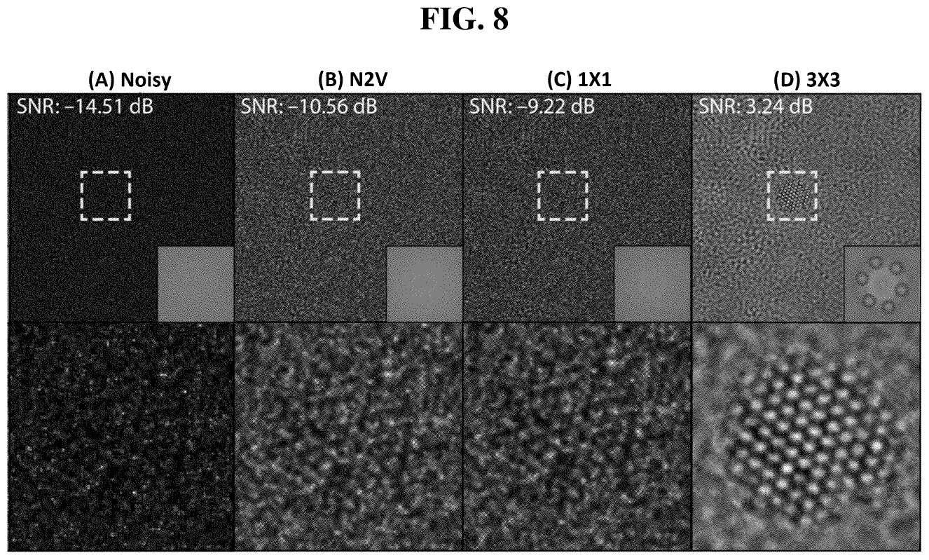

FIG. 8 illustrates actual experimental result images comparing the performance of an image restoration method according to an exemplary embodiment with conventional techniques and a comparative example.

FIG. 8 shows denoising results for actual raw data acquired in a graphene liquid cell environment. In FIG. 8, from left to right, a raw image (A) containing noise, a result (B) of applying a general self-supervised model (N2V), which is a conventional technique, a result (C) of a comparative example in which a blind-spot size is set to 1×1, and a result (D) optimized with a blind-spot size of 3×3 corresponding to noise statistics are respectively illustrated.

A dotted box marked in the center of each image in FIG. 8 indicates a central Region of Interest where nanoparticles, the observation target, are actually located. The inside of a dotted box can be utilized as a visual indicator for evaluating how intact a fine atomic-level lattice structure is restored without damage. Referring to the inside of the dotted box in the raw image (A) on the left side of FIG. 8, it can be seen that shapes and internal lattice structures of nanoparticles cannot be identified at all due to extreme physical noise.

Referring to the result image (B) of the conventional technique, it can be confirmed that noise is not properly removed throughout the entire image, and artifacts in the form of stains remain. Looking closely inside the dotted box in the result image (B) of the conventional technique, it can be seen that atomic lattice structures of nanoparticles are crushed beyond recognition due to incomplete noise removal. The conventional technique fails to restore structural information of images because it completely ignores spatial correlations among pixels of actual noise.

Referring to the result image (C) of the comparative example, it can be seen that severe noise overfitting has occurred inside the network because only a 1×1 blind-spot is simply applied without considering the diffusion radius of noise. Looking closely inside the dotted box in the result image (C) of the comparative example, a result is shown in which noise particles remain intact to the extent that there is no significant visual difference from the initial raw image. This proves that structural denoising at fine-structure levels is impossible when a blind-spot smaller than the noise diffusion radius is uniformly applied.

Referring to the result image (D) optimized with a 3×3 blind-spot size, it can be visually confirmed that overall noise is completely removed by applying a customized blind-spot having a size of 3×3 derived in the noise statistics estimation step. Referring to the inside of the dotted box in the result image (D) optimized with a 3×3 blind-spot size, it can be clearly seen that surrounding background noise is neatly erased, while fine atomic-level lattice structures constituting nanoparticles are restored very clearly without any damage.

The atomic lattice spacing restored according to the embodiment of the present disclosure may perfectly match the theoretical actual physical lattice spacing of the corresponding materials. The blind-spot neural network can fundamentally suppress hallucination phenomena that artificially create virtual fake structures not present in raw images. The embodiment of the present disclosure can provide highly reliable restored images that can be directly used as precise quantitative measures for scientific analysis.

Consequently, according to the embodiment of the present disclosure, high-quality images can be output by keeping only valid structural information fully preserved.

As can be seen from quantitative figures marked in FIG. 8, according to the embodiment of the present disclosure, a signal-to-noise ratio is dramatically increased compared to the comparative example. According to the embodiment of the present disclosure, a step of dynamically and variably determining a blind-spot size according to the actual spatial diffusion radius of noise leads to a result of improving image quality without destroying fine structures inside the dotted box. According to the embodiment of the present disclosure, the best visual contrast and signal-to-noise ratio can be achieved by perfectly suppressing noise in a background portion of a raw image.

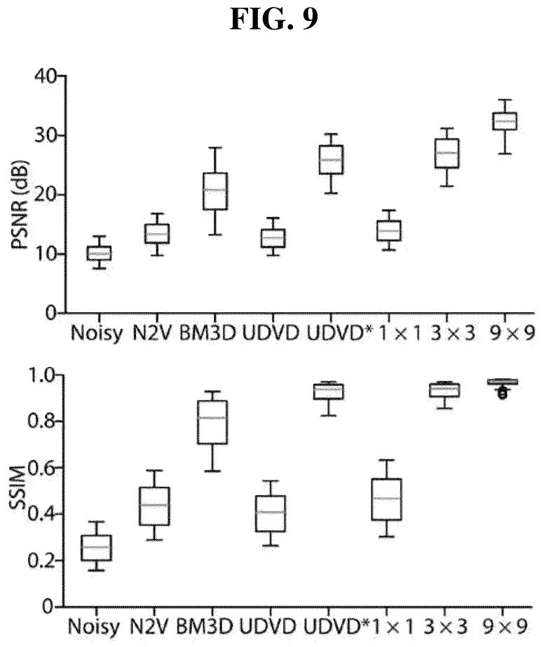

FIG. 9 is a graph comparing quantitative performance metrics of an image restoration method according to an exemplary embodiment with conventional techniques.

The performance of the image restoration method can be evaluated quantitatively using Peak Signal-to-Noise Ratio (PSNR) and Structural Similarity Index (SSIM) metrics. PSNR is an index indicating signal quality between a restored image and a ground-truth image in decibels (dB). Higher PSNR values indicate excellent quality of restored images. SSIM is an index indicating structural similarity between a restored image and a ground-truth image as a value from 0 to 1. An SSIM value closer to 1 indicates high structural similarity between a restored image and a ground-truth image.

Referring to FIG. 9, the image restoration method according to the present disclosure (applying a blind-spot neural network, blind-spot size 9×9) can show significantly improved PSNR and SSIM values compared to a noisy image, N2V, BM3D, UDVD, and UDVD*. For example, in a silicon nitride liquid cell TEM simulation dataset, the image restoration method according to the present invention can achieve a PSNR improvement of approximately 20 dB and an SSIM improvement of approximately 0.6 compared to a noisy image. In a Pt nanoparticle on ceria support simulation dataset, the image restoration method according to the present invention can achieve a PSNR improvement of approximately 20 dB and an SSIM improvement of approximately 0.9.

If a blind-spot size is set smaller than a spatial diffusion radius of noise, i.e., if a blind-spot size is set to 1×1 or 3×3, noise overfitting may occur and PSNR and SSIM values may be degraded. If a blind-spot size is set appropriately for a spatial diffusion radius of noise, for example, if a blind-spot size is set to 9×9, significantly improved PSNR and SSIM values can be achieved. Such quantitative performance improvements can be achieved because the image restoration method according to the present disclosure automatically determines a blind-spot size based on noise statistics and configures a blind-spot neural network according to the determined blind-spot size.

Such dramatic leaps in quantitative performance indicators may correspond to unexpected results that could never be easily predicted by those skilled in the art from simple conventional self-supervised denoising techniques. The image restoration method according to the present disclosure can provide a technical advance that fundamentally surpasses limitations of conventional technologies in an extreme low-dose imaging environment where ground-truth images are entirely absent.

Various features and functions of the systems, devices, and methods disclosed in the above detailed descriptions have been described in detail through exemplary embodiments with reference to the accompanying drawings. Similar symbols in drawings generally indicate similar components unless context dictates otherwise.

With respect to some or all of the ladder diagrams, scenarios, and flowcharts in the drawings, each block and/or communication may represent information processing and/or information transmission according to an exemplary embodiment. The scope of these exemplary embodiments includes alternative embodiments. In such alternative embodiments, for example, functions described as blocks, transmissions, communications, requests, responses, and/or messages may be executed in an order different from that shown or discussed depending on related functions, and may be executed substantially simultaneously or in reverse order. Further, more or fewer blocks and/or functions may be used with any one of the ladder diagrams, scenarios, and flowcharts discussed in the present disclosure, and these ladder diagrams, scenarios, and flowcharts may be partially or wholly combined with each other.

A block representing information processing may correspond to circuitry configured to perform a specific logical function of a method or technique described in the present disclosure. Alternatively or additionally, a block representing information processing may correspond to a module, segment, or portion of program code (including related data). The program code may include one or more instructions executable by a processor to implement a specific logical function or operation in a method or technique. The program code and/or related data may be stored in any type of computer-readable medium, such as a storage device including a disk, hard drive, or other storage media.

The computer-readable medium may also include non-transitory computer-readable media, which includes non-transitory computer-readable media that store data for short periods of time, such as register memory, processor cache, and Random Access Memory (RAM). The computer-readable medium may also include non-transitory computer-readable media that store data for extended periods of time, which may be secondary or persistent long-term storage, such as Read-Only Memory (ROM), optical or magnetic disks, Compact Disc Read-Only Memory (CD-ROM). The computer-readable medium may also be other volatile or non-volatile storage systems. The computer-readable medium may be considered, for example, a computer-readable storage medium or a tangible storage device.

Additionally, a block representing one or more information transmissions may correspond to information transmission between software and/or hardware modules in the same physical device. However, other information transmissions may occur between software modules and/or hardware modules in different physical devices.

While preferred or exemplary embodiments of the present disclosure have been described above, the protection scope of the present disclosure should not be construed as limited by these specific embodiments. It will be apparent to those skilled in the art that various modifications and variations can be made to the contents of the present disclosure without departing from the basic concepts and technical spirit of the present disclosure.

Such modifications and variations are intended to be included within the scope of the present disclosure, which should be defined by the appended claims and their equivalents. Arrangements, structures, devices, processes, methods, and materials of specific components described in the present disclosure and illustrated in the accompanying drawings are merely exemplary embodiments, and this should not be construed with the intention of limiting the scope of the present disclosure.

In particular, all structures, methods, and/or devices functionally equivalent to the components enumerated in the claims of the present disclosure should be considered to fall within the scope of the present disclosure, and such equivalents will be apparent to those skilled in the art from the above detailed description.

Accordingly, the scope of the present disclosure should be determined solely by the appended claims, and terms, examples, and embodiments used in the detailed description should not be construed in a manner that limits the scope of the claims. It is clarified that the present disclosure encompasses combinations and sub-combinations of all components that are not previously disclosed or known.

1. A method for image restoration, the method comprising:
obtaining a single dataset including a plurality of raw images containing noise;
estimating noise statistics by performing spatial correlation analysis among the raw images included in the single dataset;
determining a blind-spot size based on the noise statistics;
training a blind-spot neural network configured according to the determined blind-spot size in a self-supervised manner using the single dataset; and
generating a restored image from the raw images using the blind-spot neural network.

2. The method of claim 1, wherein the estimating of the noise statistics by performing the spatial correlation analysis among the raw images included in the single dataset comprises:
shifting a raw image tensor selected from the single dataset by a pixel unit in a first direction and a second direction, respectively;
calculating correlation values between the shifted tensor and an original tensor; and
generating a two-dimensional (2D) spatial correlation heatmap using the correlation values.

3. The method of claim 2, wherein the determining of the blind-spot size based on the noise statistics comprises:
measuring a spatial diffusion radius in which a correlation value equal to or greater than a preset threshold is maintained in the 2D spatial correlation heatmap; and
determining a physical blocking area in a form of N×N pixels, where N is an odd number equal to or greater than 1, as the blind-spot size in proportion to the number of pixels of the measured spatial diffusion radius.

4. The method of claim 1, wherein the blind-spot neural network includes a dilated convolution layer, and
a dilation rate of the dilated convolution layer is set based on the determined blind-spot size.

5. The method of claim 1, wherein the training of the blind-spot neural network configured according to the determined blind-spot size in the self-supervised manner using the single dataset comprises:
extracting a patch having a preset pixel size from the raw images included in the single dataset;
augmenting training data by applying a geometric transformation to the patch; and
self-updating a parameter by backpropagating a loss in a direction that minimizes a mean squared error (MSE) between a prediction result tensor of the blind-spot neural network and a raw image assigned as an inference target.

6. The method of claim 1, wherein the raw images included in the single dataset are provided as a training input of the blind-spot neural network and an inference target for calculating a loss function.

7. A device for image restoration, comprising:
a data storage storing one or more instructions; and
a processor executing the one or more instructions,
wherein the processor is configured to:
obtain a single dataset including a plurality of raw images containing noise;
estimate noise statistics by performing spatial correlation analysis among the raw images included in the single dataset;
determine a blind-spot size based on the noise statistics;
train a blind-spot neural network configured according to the determined blind-spot size in a self-supervised manner using the single dataset; and
generate a restored image from the raw images using the blind-spot neural network.

8. The device of claim 7, wherein, when estimating the noise statistics by performing the spatial correlation analysis among the raw images included in the single dataset, the processor is configured to:
shift a raw image tensor selected from the single dataset by a pixel unit in a first direction and a second direction, respectively;
calculate correlation values between the shifted tensor and an original tensor; and
generate a two-dimensional (2D) spatial correlation heatmap using the correlation values.

9. The device of claim 8, wherein, when determining the blind-spot size based on the noise statistics, the processor is configured to:
measure a spatial diffusion radius in which a correlation value equal to or greater than a preset threshold is maintained in the 2D spatial correlation heatmap; and
determine a physical blocking area in a form of N×N pixels, where N is an odd number equal to or greater than 1, as the blind-spot size in proportion to the number of pixels of the measured spatial diffusion radius.

10. The device of claim 7, wherein the blind-spot neural network includes a dilated convolution layer, and
a dilation rate of the dilated convolution layer is set based on the determined blind-spot size.

11. The device of claim 7, wherein, when training the blind-spot neural network configured according to the determined blind-spot size in the self-supervised manner using the single dataset, the processor is configured to:
extract a patch having a preset pixel size from the raw images included in the single dataset;
augment training data by applying a geometric transformation to the patch; and
self-update a parameter by backpropagating a loss in a direction that minimizes a mean squared error (MSE) between a prediction result tensor of the blind-spot neural network and a raw image assigned as an inference target.

12. The device of claim 7, wherein the raw images included in the single dataset are provided as a training input of the blind-spot neural network and an inference target for calculating a loss function.
